(19) United States
(12) Patent Application Publication
(10) Pub. No.: US 2020/0325289 A1
(43) Pub. Date: Oct. 15, 2020

(54) CURABLE FILM-FORMING COMPOSITIONS CONTAINING RHEOLOGY MODIFIERS COMPRISING NON-AQUEOUS DISPERSIONS

(71) Applicant: PPG INDUSTRIES OHIO, INC., Cleveland, OH (US)

(72) Inventors: BIN CAO, PITTSBURGH, PA (US); DAVID ROBERT FENN, ALLISON PARK, PA (US); DENNIS ALLAN SIMPSON, SARVER, PA (US); WEI WANG, ALLISON PARK, PA (US); MATTHEW S. LUCHANSKY, WEXFORD, PA (US); CHIN MING HUI, PITTSBURGH, PA (US); INANLLELY YUDERKA GONZALEZ, PITTSBURGH, PA (US)

(73) Assignee: PPG INDUSTRIES OHIO, INC., CLEVELAND, OH (US)

(21) Appl. No.: 16/383,784

(22) Filed: Apr. 15, 2019

(51) Int. Cl. C08J 5/18; C08J 3/24; C08J 3/03; C08L 33/06; C08L 67/00; C08K 3/36; B05D 7/00; B05D 7/14; B05D 5/06

(52) U.S. Cl. CPC C08J 5/18; C08J 3/24; C08J 3/03; C08L 33/06; C08L 67/00; C08K 3/36; C08J 2367/00; B05D 7/14; B05D 5/06; C08J 2463/00; C08J 2333/08; C08J 2333/10; B05D 7/5323

(57) ABSTRACT

A curable film-forming composition is provided, comprising:
(a) a polymeric binder comprising epoxy functional groups;
(b) a curing agent comprising acid functional groups that are reactive with the epoxy functional groups of (a);
(c) a non-aqueous dispersion comprising a dispersion polymerization reaction product of a reaction mixture comprising an ethylenically unsaturated monomer and a nonlinear, random, acrylic polymer stabilizer; and
(d) fumed silica. The dispersion polymerization reaction product in the non-aqueous dispersion (c) is present in the curable film-forming composition in an amount of 0.5 to 10 percent by weight, and the fumed silica (d) is present in an amount of 0.5 to 5 percent by weight, based on the total weight of resin solids in the curable film-forming composition. Also provided are multi-layer coated articles that include the curable film-forming compositions described above.

### FIELD OF THE INVENTION

The present invention relates to curable film-forming compositions that comprise non-aqueous dispersions.

### BACKGROUND OF THE INVENTION

Color-plus-clear coating systems involving the application of a colored or pigmented basecoat to a substrate followed by the application of a transparent or clear topcoat to the basecoat are standard in the industry as original finishes for automobiles. The color-plus-clear systems have outstanding gloss and distinctness of image, and the clear topcoat is particularly important for these properties.

Often during application of the coatings to an automotive substrate, which is typically done by spraying, the appearance of a coating (such as its smoothness) is different when applied to a horizontally oriented substrate surface than when applied to a vertically oriented surface. This can result in noticeably different surface appearances in different areas of the same vehicle. Uniformity of vehicle appearance can be impacted by efforts to balance workability of the formulated coatings and appearance, and developing tools that improve coating flow and leveling behavior without hurting sag resistance. In addition to the focus on horizontal/vertical uniformity, an optimal balance of sag resistance and appearance is also advantageous for good appearance in difficult shapes and contours that are prone to sags and drips during coating application.

It would be desirable to provide a curable film-forming composition that demonstrates improved appearance properties over an entire substrate surface without loss of cured film properties such as acid etch resistance and UV durability.

### SUMMARY OF THE INVENTION

The present invention provides a curable film-forming composition comprising:

(a) a polymeric binder comprising epoxy functional groups;

(b) a curing agent comprising acid functional groups that are reactive with the epoxy functional groups of (a);

(c) a non-aqueous dispersion comprising a dispersion polymerization reaction product of a reaction mixture comprising an ethylenically unsaturated monomer and an ethylenically unsaturated nonlinear, random, acrylic polymer stabilizer, wherein the dispersion polymerization reaction product in the non-aqueous dispersion is present in the curable film-forming composition in an amount of 0.5 to 10 percent by weight, based on the total weight of resin solids in the curable film-forming composition, and wherein the dispersion polymerization reaction product is different from the polymeric binder (a); and

(d) fumed silica, present in the curable film-forming composition in an amount of 0.5 to 5 percent by weight, based on the total weight of resin solids in the curable film-forming composition.

Also provided are multi-layer coated articles that include the curable film-forming compositions described above.

### DETAILED DESCRIPTION

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”)), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Plural referents as used herein encompass singular and vice versa. For example, while the invention has been described in terms of “an” acrylic resin having epoxy functional groups, a plurality, including a mixture of such resins can be used.

Any numeric references to amounts, unless otherwise specified, are “by weight”. The term “equivalent weight” is a calculated value based on the relative amounts of the various ingredients used in making the specified material and is based on the solids of the specified material. The relative amounts are those that result in the theoretical weight in grams of the material, like a polymer, produced from the ingredients and give a theoretical number of the particular functional group that is present in the resulting polymer. The theoretical polymer weight is divided by the theoretical number of equivalents of functional groups to give the equivalent weight. For example, urethane equivalent weight is based on the equivalents of urethane groups in the polyurethane material.

The curable film-forming compositions of the present invention are typically solventborne. As used herein, the terms “thermosetting” and “curable” can be used interchangeably and refer to resins that “set” irreversibly upon curing or crosslinking, wherein the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Once cured or crosslinked, a thermosetting resin will not melt upon the application of heat and is insoluble in solvents. Additionally, as used herein, the terms “film-forming” and “coating” can be used interchangeably.

The curable film-forming compositions of the present invention comprise (a) a polymeric binder comprising reactive epoxy functional groups. The polymeric binder is a film-forming binder and may be selected from one or more of acrylic polymers, polyesters, polyurethanes, polyamides, polyethers, polythioethers, polythioesters, polyenes, and epoxy resins. Often the polymeric binder (a) comprises an acrylic and/or a polyester polymer. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C. Generally these polymeric binders can be made by any appropriate polymerization method known to those skilled in the art. The epoxy functional groups on the film-forming binder are reactive with the acid functional groups on the curing agent (b).

Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and often 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms, but which do not contain ethylenic unsaturation.

Useful ethylenically unsaturated, epoxy functional monomers used to prepare the beta-hydroxy ester functional monomers include glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. (Note: these epoxy functional monomers may also be used to provide epoxy functionality to the acrylic polymers.) Examples of carboxylic acids include saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio; i. e., the ratio of equivalents of acid functional groups to equivalents of epoxy functional groups. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 6 to 30 carbon atoms, such as butyl glycidyl ether, octyl glycidyl ether, phenyl glycidyl ether and para-(tertiary butyl) phenyl glycidyl ether. Particular glycidyl esters include those of the structure:

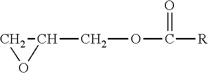

where R is a hydrocarbon radical containing from about 4 to about 26 carbon atoms. Typically, R is a branched hydrocarbon group having from about 5 to about 10 carbon atoms, such as neopentanoate, neoheptanoate or neodecanoate. Suitable glycidyl esters of carboxylic acids include CARDURA E and glycidyl esters of VERSATIC ACID 911, each of which are commercially available from Shell Chemical Co.

Acrylic polymers can be prepared via organic solution polymerization techniques for solventborne compositions. Generally any method of producing such polymers that is known to those skilled in the art utilizing art recognized amounts of monomers can be used.

Besides acrylic polymers, the polymeric binder (a) in the curable film-forming composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil.

Likewise, polyamides may be prepared utilizing polyacids and polyamines. Suitable polyacids include those listed above and polyamines may be selected from at least one of ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

Polyurethanes can also be used as the polymeric binder (a) in the curable film-forming composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are typically used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate polymethylene polyphenyl isocyanate, and isocyanate trimers based on 1,6-hexamethylene diisocyanate or isophorone diisocyanate.

Examples of polyether polymers are polyalkylene ether polyols which include those having the following structural formula:

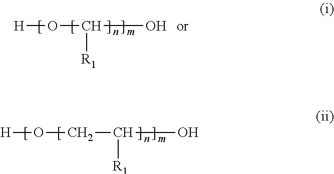

where the substituent R₁ is hydrogen or lower alkyl containing from 1 to 5 carbon atoms including mixed substituents, and n is typically from 2 to 6 and m is from 8 to 100 or higher. Included are poly(tetramethylene) glycols, poly(tetraethylene) glycols, poly(1,2-propylene) glycols, and poly(1,2-butylene) glycols.

Also useful are polyether polymers formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst.

As discussed above, epoxy functional film-forming polymers may be acrylic polymers prepared with epoxy functional monomers such as glycidyl acrylate, glycidyl methacrylate, allyl glycidyl ether, and methallyl glycidyl ether. Polyesters, polyethers, polyurethanes, or polyamides prepared with glycidyl alcohols or glycidyl amines, or reacted with an epihalohydrin are also suitable epoxy functional resins. Epoxide functional groups may be incorporated into a resin by reacting hydroxyl groups on the resin with an epihalohydrin or dihalohydrin such as epichlorohydrin or dichlorohydrin in the presence of alkali.

Other suitable epoxy functional polymers for use as the polymeric binder (a) may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

The equivalent ratio of reactants; i. e., epoxy:polyhydroxyl group-containing material is typically from about 1.00:0.75 to 1.00:2.00.

The polyepoxide by definition has at least two 1,2-epoxy groups. In general the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as any of those disclosed above. The present invention may comprise epoxy resins such as diglycidyl ethers of Bisphenol A, Bisphenol F, glycerol, novolacs, and the like. Exemplary suitable polyepoxides are described in U.S. Pat. No. 4,681,811 at column 5, lines 33 to 58, the cited portion of which is incorporated by reference herein.

The amount of the polymeric binder (a) in the curable film-forming composition generally ranges from 5 to 50 percent by weight based on the total weight of resin solids in the curable film-forming composition. The minimum amount of polymeric binder may be at least 5 percent by weight, often at least 10 percent by weight and more often, at least 25 percent by weight. The maximum amount of polymeric binder may be 50 percent by weight, more often 35 percent by weight, or 30 percent by weight. For example, the amount of the polymeric binder (a) in the curable film-forming composition may range from 5 to 50 percent by weight, or 5 to 35 percent by weight, or 5 to 30 percent by weight, or 10 to 50 percent by weight, or 10 to 35 percent by weight, or 10 to 30 percent by weight, or 25 to 50 percent by weight, or 25 to 35 percent by weight, or 25 to 30 percent by weight, based on the total weight of resin solids in the curable film-forming composition.

Suitable curing agents (b) for use in the curable film-forming compositions of the present invention comprise acid-functional and/or anhydride-functional groups that are reactive with the epoxy functional groups in the polymeric binder (a). Examples of suitable polycarboxylic acids include adipic, succinic, sebacic, azelaic, and dodecanedioic acid. Other suitable polyacid crosslinking agents include acid group-containing acrylic polymers prepared from an ethylenically unsaturated monomer containing at least one carboxylic acid group and at least one ethylenically unsaturated monomer that is free from carboxylic acid groups. Such acid functional acrylic polymers can have an acid number ranging from 30 to 150. Acid functional group-containing polyesters can be used as well. Low molecular weight polyesters and half-acid esters can be used which are based on the condensation of aliphatic polyols with aliphatic and/or aromatic polycarboxylic acids or anhydrides. Examples of suitable aliphatic polyols include ethylene glycol, propylene glycol, butylene glycol, 1,6-hexanediol, trimethylol propane, di-trimethylol propane, neopentyl glycol, 1,4-cyclohexanedimethanol, pentaerythritol, and the like. The polycarboxylic acids and anhydrides may include, inter alia, terephthalic acid, isophthalic acid, phthalic acid, phthalic anhydride, tetrahydrophthalic acid, tetrahydrophthalic anhydride, hexahydrophthalic anhydride, methylhexahydrophthalic anhydride, chlorendic anhydride, and the like. Mixtures of acids and/or anhydrides may also be used. The above-described polyacid crosslinking agents are described in further detail in U.S. Pat. No. 4,681,811, at column 6, line 45 to column 9, line 54, which is incorporated herein by reference.

Appropriate mixtures of crosslinking agents may also be used in the invention. For example, two or more different acid functional acrylic polymers, two or more different acid functional polyester polymers, or a mixture of two or more different acid functional acrylic polymers and acid functional polyester polymers may be used as the curing agent (b). The curable film-forming composition of the present invention may further comprise one or more additional crosslinking agents different from the acid functional curing agent (b). Examples include aminoplasts and polyisocyanates. Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. Formaldehyde is the most commonly used aldehyde, but other aldehydes such as acetaldehyde, crotonaldehyde, and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol, and hexanol can be employed for this purpose. Nonlimiting examples of suitable aminoplast resins are commercially available from Cytec Industries, Inc. under the trademark CYMEL® and from Ineos under the trademark RESIMENE®.

Other crosslinking agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Although higher polyisocyanates such as isocyanurates of diisocyanates are often used, diisocyanates can also be used. Isocyanate prepolymers, for example reaction products of polyisocyanates with polyols also can be used. Mixtures of polyisocyanate crosslinking agents can be used.

The polyisocyanate can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups may be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine.

The amount of the curing agent in the curable film-forming composition generally ranges from 5 to 75 percent by weight based on the total weight of resin solids in the curable film-forming composition. For example, the minimum amount of curing agent may be at least 5 percent by weight, often at least 10 percent by weight and more often, at least 15 percent by weight. The maximum amount of curing agent may be 75 percent by weight, more often 60 percent by weight, or 55 percent by weight. Ranges of curing agent may include, for example, 5 to 50 percent by weight, 5 to 60 percent by weight, 10 to 50 percent by weight, 10 to 60 percent by weight, 10 to 75 percent by weight, 15 to 50 percent by weight, 15 to 60 percent by weight, and 15 to 75 percent by weight.

The curable film-forming compositions of the present invention additionally comprise (c) a non-aqueous dispersion comprising a dispersion polymerization reaction product of an ethylenically unsaturated monomer and a nonlinear, random, acrylic polymer stabilizer. The dispersion polymerization reaction product is different from the polymeric binder (a). As used herein, the term “nonlinear” means that there is at least one branch point along and extending from the backbone of the polymer. “Branching” as used herein is defined in Compendium of Polymer Terminology and Nomenclature, IUPAC Recommendations 2008, published by RSC Publishing, ISBN: 978-0-85404-491-7. Often the branches are polymeric and are derived from ethylenically unsaturated monomers such as (meth)acrylic monomers. In some cases, there may be multiple branch points (i.e. “hyperbranched”), and in some examples, the branches can form connections between polymer chains (i.e. internal crosslinks). Polymer branching can be quantified using the Mark-Howink parameter. In certain examples, the Mark-Howink parameter of the present nonlinear acrylic polymer stabilizers as measured by triple detector GPC is 0.2-0.7, such as 0.3-0.6.

The nonlinear stabilizer is “random” or predominantly homogenous. That is, the polymer is substantially free of blocks or segments having a composition distinct from the remainder of the polymer. For example, in a typical “comb” polymer, the backbone of the polymer has one composition, while the “teeth” of the comb have another. That is not the case with a random or homogenous polymer in which the monomers are allowed to react freely and are not reacted in a predetermined pattern or order. As a result, the monomers are randomly assembled in the final polymer.

The term “acrylic polymer stabilizer” as used in the context of the present invention refers to a polymer that comprises 50 percent by weight or greater residues derived from (meth)acrylic monomers, based on the total weight of the polymer. As used herein, and as is conventional in the art, the use of (meth) in conjunction with another word, such as acrylate, refers to both the acrylate and the corresponding methacrylate. In certain examples, the nonlinear acrylic polymer stabilizers are prepared from a reaction mixture comprising 75 percent by weight or greater, such as 90 percent by weight or greater or 95 percent by weight or greater of (meth)acrylic monomers. In certain examples the stabilizer is prepared from a reaction mixture comprising 100 percent by weight (meth)acrylic monomers. The term “(meth)acrylic monomer” excludes polymeric species such as macromonomers. The stabilizer may be prepared from polar (meth)acrylic monomers, such as hydroxyl functional (meth)acrylic monomers, in an amount of 30 percent by weight or less, such as 20 percent by weight or less, 15 percent by weight or less or 10 percent by weight or less. In other examples, the stabilizer may be prepared from nonpolar (meth)acrylic monomers, such as 2-ethyl hexyl acrylate, which can be in amounts of 50 percent by weight or greater, such as 60 percent by weight or greater, 70 percent by weight or greater or 80 percent by weight or greater. Percent by weight, as used in the context of percent by weight of monomers, refers to the percent by weight of monomers used in the formation of the stabilizer, and does not include other ingredients, such as initiators, chain transfer agents, additives and the like, used to form the stabilizer. “Acrylic” monomers refer generally to acrylics, methacrylics, and any derivatives of any of these.

The nonlinear acrylic polymer stabilizer can be prepared by reacting two or more coreactive monomers, such as glycidyl (meth)acrylate and (meth)acrylic acid, or by preparing an acrylic polymer with functional groups and crosslinking the functionality, such as by making a hydroxyl functional polymer and reacting it with a diisocyanate or an epoxy functional polymer and reacting it with a diacid. In a particularly suitable example, the nonlinear acrylic polymer stabilizer can be prepared from a reaction mixture comprising one or more polyfunctional ethylenically unsaturated monomers. Suitable polyfunctional ethylenically unsaturated monomers include allyl (meth)acrylate, alkane diol di(meth)acrylates such as 1,6-hexane diol diacrylate or ethylene glycol dimethacrylate, trimethylol propane triacrylate, and divinylbenzene.

The use of a polyfunctional ethylenically unsaturated monomer in the formation of the acrylic polymer stabilizer allows for polymeric nonlinearity of the polymer. Typically, the polyfunctional monomer will be used in an amount of 0.1 to 10 percent by weight, such as 0.25 to 5 or 0.5 to 2 percent by weight, based on the total weight of monomers used to prepare the stabilizer. If the polyfunctional monomer is used in amounts too high, gelling can occur. The level of polyfunctional monomer can be chosen so as to give the desired amount of nonlinearity or branching without gelling the product. One or more polyfunctional ethylenically unsaturated monomers can be used. In some examples, the two (or more) ethylenically unsaturated functional groups within the same monomer molecule may have different reactivities towards the other (meth)acrylate monomers used to form the stabilizer. Each polyfunctional ethylenically unsaturated monomer molecule may react completely with other (meth)acrylate monomers to form polymeric branches or crosslinks, or it may react incompletely and retain at least one of its ethylenically unsaturated functional groups. The resulting nonlinear acrylic polymer stabilizer will have ethylenic unsaturation, which may be due to unreacted ethylenically unsaturated groups on a polyfunctional monomer, or which may be added to the acrylic polymer stabilizer by post-reacting pendant functional groups on the polymer stabilizer with an ethylenically unsaturated monomer that has additional functional groups that are reactive with the pendant groups on the polymer stabilizer. For example, a pendant acid functional group on the acrylic polymer stabilizer may be post-reacted with an epoxy functional monomer such as glycidyl methacrylate to yield a free ethylenically unsaturated group. This unsaturation is then available to react during the preparation of the non-aqueous dispersion, allowing the nonlinear acrylic polymer stabilizer to be covalently bonded to the ethylenically unsaturated core monomers during polymerization of the core monomers to form the non-aqueous dispersions, as further described below.

In the formation of the nonlinear acrylic polymer stabilizer, the polyfunctional monomer will be polymerized with one or more additional ethylenically unsaturated monomers and an initiator, such as a free radical initiator. Suitable monomers include methyl (meth)acrylate, ethyl (meth)acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl (meth)acrylate, styrene, alpha-methylstyrene, lauryl (meth)acrylate, stearyl (meth)acrylate, itaconic acid and its esters, and the like. As noted above, 50 percent by weight or greater of the monomers used in the formation of the stabilizer are acrylic. Suitable free radical initiators include peroxy initiators such as benzoyl peroxide, lauroyl peroxide, or tert-butylperoxy-2-ethyl-hexanoate (tert-butylperoctoate) and azo initiators such as 2,2′-azobis (2,4-dimethylpentane nitrile) or 2,2′-azobis (2-methylbutane nitrile).

Generally, the nonlinear acrylic polymer stabilizers are formed by solution polymerization of the ethylenically unsaturated monomers, at least one of which is polyfunctional, by a standard radical polymerization method known to those skilled in the art. For example, the ethylenically unsaturated monomers can be added over a period of time to a suitable solvent at an elevated temperature, such as at the reflux temperature of the solvent. A radical initiator, such as a peroxide initiator, is added to the reaction mixture over approximately the same time period. The initiator is chosen so that it will induce radical polymerization of the monomers at the selected reaction temperature. After the monomers and initiator have been added to the reaction mixture, the mixture may be held at the reaction temperature for an extended period of time, during which additional initiator may be added to ensure complete conversion of the monomers. Progress of the reaction may be monitored by solids measurement, or by gas chromatography.

The stabilizer can be prepared in a continuous reactor. For example, (meth)acrylate monomers and a radical initiator, such as a peroxide initiator, can be fed continuously through a continuous reactor with a 1 to 20 minute residence time at 150-260° C. The (meth)acrylate monomers used herein could be polar, non-polar, or a mixture of both types.

The molar ratio of acrylate to methacrylate can be about 2:1. For example, the initiator level is 0.5 to 2.0%, such as 1.0 to 1.5% based on the total weight of the monomers.

The stabilizer can have a weight average molecular weight as measured by gel permeation chromatography relative to linear polystyrene standards of 10,000 to 1,000,000, such as 20,000 to 80,000, or 30,000 to 60,000. The stabilizer comprises ethylenic unsaturation, as detected by ¹³C NMR spectroscopy. The stabilizer can contain additional functional groups, such as hydroxyl groups, carboxylic acid groups, and/or epoxy groups.

In certain embodiments, the van Krevelen solubility parameter of the acrylic polymer stabilizer at 298 K is 17 to 28 MPa^{0.5}, such as 17.5 to 20 MPa^{0.5} or 18 to 19 MPa^{0.5}. In the case of a copolymer, the solubility parameter can be calculated from the weighted average of the van Krevelen solubility parameter of the homopolymers derived from the individual monomers. The van Krevelen solubility parameter for a homopolymer is calculated using Synthia implemented in Material Studio 5.0, available from Accelrys, Inc., San Diego, Calif.

The stabilizer is further reacted with a monomer or a mixture of monomers having ethylenic unsaturation. These monomers are sometimes referred to herein as the “core monomers”, as distinguished from the monomers used to prepare the stabilizer. The core monomer(s) and the stabilizer react through the ethylenic unsaturation by dispersion polymerization techniques, which are known to those skilled in the art. For example, the stabilizer may be dissolved in a suitable solvent or mixture of solvents, and the monomer(s) may be added to the solution at an elevated temperature over a period of time, during which a radical initiator is also added to the mixture. The monomer(s) may be added in a single timed feed, or they may be added in stages, such as in two stages. The composition of the monomers may be the same or different when added either at the same time or different times.

Suitable core monomers include methyl (meth)acrylate, ethyl (meth)acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl (meth)acrylate, styrene, alpha-methylstyrene, lauryl (meth)acrylate, stearyl (meth)acrylate, itaconic acid and its esters, and the like. In certain examples the monomers comprise a polyfunctional ethylenically unsaturated monomer including allyl (meth)acrylate, alkane diol di(meth)acrylates, such as 1,6-hexanediol diacrylate, and ethylene glycol dimethacrylate; trimethylol propane triacrylate, divinylbenzene, or other suitable poly(meth)acrylate.

Solubility parameters for solvents can be obtained from “Hansen solubility parameters: a user's handbook”, Charles M. Hansen, CRC Press, Inc., Boca Raton Fla., 2007. The solubility parameter of a mixture of solvents can be calculated from the weighted average of the solubility parameter of the individual solvents. The acrylic polymer stabilizer will generally be compatible with the continuous phase of the non-aqueous dispersion. By “compatible” is meant, for example, the solubility parameter of the solvent is often lower than that of the stabilizer, such as a difference of 3 units or less, or 2.5 units or less; if the difference is more than 3 units, then the stabilizer may not be soluble in the solvent. As used in reference to solubility parameter, “units” refers to MPa^{0.5}.

It is to be understood that the “dispersion polymerization reaction product”, used interchangeably with “polymerization reaction product” is the product that results upon reaction of the ethylenically unsaturated monomer component (i.e. the core monomers) and the acrylic polymer stabilizer. The polymerization reaction product may comprise functionality such as epoxy and/or hydroxyl functionality.

The polymerization reaction product may contain epoxy functionality as noted above. In certain examples, the epoxy equivalent weight of the polymerization reaction product can be from 100 to 5000, such as from 200 to 2000. The epoxy functionality may be introduced, for example, by using an ethylenically unsaturated epoxy functional monomer, such as glycidyl (meth)acrylate, as a core monomer. Alternatively, the epoxy functionality may be introduced by using an ethylenically unsaturated epoxy functional monomer in the acrylic polymer stabilizer. In certain embodiments, the epoxy functionality can be introduced by using an ethylenically unsaturated epoxy functional monomer in both the acrylic polymer stabilizer and as a core monomer. In certain other examples, the epoxy functionality may be introduced by post-modifying the polymerization reaction product after the non-aqueous dispersion is formed. For example, the polymerization reaction product of the non-aqueous dispersion may be hydroxyl functional, and it can be reacted with a compound that contains both a functional group that reacts with the hydroxyl group and an epoxy group that does not react. In any of these embodiments, the final polymerization reaction product would be epoxy functional.

In certain examples, the polymerization reaction product of the non-aqueous dispersion may comprise more than one type of functionality. For example, the polymerization reaction product may comprise both epoxy and hydroxyl functionality. The functionality may be introduced by using any of the methods described above for the introduction of epoxy functionality. In certain embodiments, the theoretical hydroxyl value can be from 30 to 300, such as from 40 to 280, or from 50 to 230. The polymerization reaction product of the non-aqueous dispersion may further comprise acid functionality. In certain embodiments, the theoretical acid value may be from 0 to 80, such as from 0 to 40 or 5 to 20.

The reaction of the core monomer(s) with the stabilizer may result in the formation of a particle. The weight average molecular weight of the dispersion polymerization reaction product as measured by gel permeation chromatography against a linear polystyrene can be very high, such as 100,000 g/mol, or can be so high as to be immeasurable due to gel formation within the particle. Having particles with high gel content may, when used in a coating, contribute to one or more enhanced properties, such as improved appearance, resistance to solvents, acids and the like, improved sag resistance, improved metallic flake orientation, and/or improved resistance to interlayer mixing when multiple coating layers are applied. In certain examples, the gel content of the dispersion as measured by the ultracentrifuge separation method is 30 weight percent or greater, such as 40 weight percent or greater, with weight percent based on total solid weight. In the ultracentrifuge separation method on which these values are based, 2 grams of the dispersion is added into a centrifuge tube and then the tube is filled with 10 grams of a solvent such as tetrahydrofuran (THF), and the materials are mixed thoroughly. The prepared centrifuge tube is placed in an ultracentrifuge at a speed at 50,000 rpm or greater, for 30 min or longer. The undissolved fraction of the dispersion is separated and dried to constant weight at 110° C. to provide the gel content of the dispersion.

The dispersion polymerization reaction product in the non-aqueous dispersions used in the curable film-forming compositions of the present invention may be internally crosslinked or uncrosslinked. Crosslinked dispersion polymerization reaction products may be desired in certain circumstances over uncrosslinked dispersion polymerization reaction products because uncrosslinked materials are more likely to swell or dissolve in the organic solvents used the coating compositions. Crosslinked dispersion polymerization reaction products may have a significantly higher molecular weight as compared to uncrosslinked dispersions. Crosslinking of the dispersion polymerization reaction product can be achieved, for example, by including a polyfunctional ethylenically unsaturated monomer (or a crosslinking agent) with the ethylenically unsaturated core monomer or monomer mixture during polymerization. The polyfunctional ethylenically unsaturated monomer can be present in amounts of 0 to 20% by weight based on the total weight of the core monomers used in preparing the dispersion polymerization reaction product, such as from 1 to 10% by weight.

In certain examples, the core monomers polymerized with the acrylic polymer stabilizer comprises less than 90% by weight of a polar and/or functional monomer. The term “polar” as used herein refers to monomers or compounds that have a solubility parameter (van Krevelen) at 298 K of 19 MPa^{0.5} or more. Conversely, the term “non-polar” describes substances that have a solubility parameter (van Krevelen) at 298 K lower than 19 MPa^{0.5}.

In certain examples of the present invention, the reaction mixture used to prepare the dispersion polymerization reaction product may further comprise an aliphatic polyester stabilized seed polymer. As used herein, the term “aliphatic polyester” refers to a polyester that is soluble in an aliphatic hydrocarbon solvent such as heptane. The carbon to oxygen ratio of the polyester can be used to predict this solubility. The ratio can be calculated from the mole ratio of the monomers minus the water of esterification. For example, if the carbon to oxygen ratio of the polyester is from 4:1 to 20:1, such as from 6:1 to 12:1, the polyester would be soluble in a hydrocarbon solvent such as heptane, or in a slightly more polar solvent system, such as 60% ISOPAR K and 40% butyl acetate. ISOPAR K is a hydrocarbon solvent commercially available from the Exxon-Mobile Company. A suitable polyester would be, for example, poly-12-hydroxy stearic acid, which has a carbon to oxygen ratio of 9:1.

The aliphatic polyester can be used to prepare a stabilizer, sometimes referred to herein as the “seed stage stabilizer”, for the seed stage of the preparation of the dispersion polymerization reaction product. The seed stage stabilizer may comprise two segments, one of which comprises the aliphatic polyester described above, and one of which is of a different polarity from the polyester and is relatively insoluble in the aliphatic hydrocarbon solvent. The first of these is sometimes referred to herein as the “aliphatic polyester component” and the second as the “stabilizer component”. Suitable stabilizer components are known and some examples have been described in U.S. Pat. No. 4,147,688, Column 5, Line 1-Column 6, Line 44, incorporated by reference herein.

The aliphatic polyester component can comprise poly-12-hydroxy stearic acid having a number average molecular weight of about 300 to 3,000 and comprising both acid and hydroxyl functionality. The poly-12-hydroxystearic acid may then be reacted with a compound that comprises (meth)acrylate functionality as well as a second type of functional group that can react with the hydroxyl or acid functionality of the poly-12-hydroxy stearic acid. A suitable compound would be, for example, glycidyl(meth)acrylate. The reaction product of the poly-12-hydroxy stearic acid and glycidyl(meth)acrylate can be further reacted with an ethylenically unsaturated monomer having a different polarity from poly-12-hydroxy stearic acid by a standard free-radical polymerization reaction to provide the polyester stabilizer of the present invention. Suitable ethylenically unsaturated monomers include but are not limited to (meth)acrylic acid, methyl(meth)acrylate, ethyl(meth)acrylate, n-butyl(meth)acrylate, isobutyl(meth)acrylate, 2-ethylhexyl(meth)acrylate, isobornyl(meth)acrylate, 2-hydroxyethyl(meth)acrylate, 2-hydroxypropyl(meth)acrylate, (meth)acrylic acid, glycidyl(meth)acrylate, styrene, alpha-methylstyrene, lauryl(meth)acrylate, stearyl(meth)acrylate, itaconic acid and its esters, and the like. In one embodiment, the ethylenically unsaturated monomer comprises methyl methacrylate, glycidyl methacrylate, and methacrylic acid. It will be appreciated that standard free-radical polymerization techniques are well-known to those skilled in the art. The seed stage stabilizer may be from 20 percent by weight to 65 percent by weight polyester, such as from 25 percent by weight to 60 percent by weight, 30 percent by weight to 55 percent by weight, or 33 percent by weight to 53 percent by weight polyester, with percent by weight based on the total weight of the components of the seed stage stabilizer.

The seed stage stabilizer can be used to prepare a seed polymer. As used herein, the term “seed polymer” refers to a dispersed polymer that has a particle size smaller than 80 nm, such as smaller than 50 nm. The seed polymer generally comprises the seed stage stabilizer described above and dispersed polymer. The seed polymer can be prepared by dissolving the seed stage stabilizer in a suitable solvent or mixture of solvents, and the monomer(s) used to form the seed polymer (“seed monomer(s)”) may be added to the solution at an elevated temperature over a period of time, during which a radical initiator may also be added to the mixture. The dispersed polymer can be covalently bonded, or grafted, to the seed stage stabilizer. A seed polymer can be prepared, for example, from a seed stage stabilizer and an ethylenically unsaturated monomer such as a (meth)acrylate monomer. The polymer formed from the ethylenically unsaturated monomer should be insoluble in the continuous phase in order to provide a stable dispersion, as opposed to a solution. It will be appreciated by those skilled in the art that, if the seed stage stabilizer comprises ethylenic unsaturation, then in addition to the polymerization of the seed monomer(s) with other seed monomer(s), at least some of the polymerizable double bonds of the stabilizer will react with some of the seed monomer(s) under these conditions. Through this process, the seed polymer will become grafted, that is, covalently bonded, to the seed stage stabilizer. A suitable seed polymer can be prepared from a seed stage stabilizer comprising poly-12-hydroxystearic acid in 60% ISOPAR K and 40% butyl acetate and methyl methacrylate.

The seed polymer as described above can be a stable dispersion. For example, the seed polymer can be prepared and stored for use at a later time. Alternatively, it can be used immediately in the preparation of the non-aqueous dispersion. When the seed polymer is used, the weight ratio of the seed polymer to the ethylenically unsaturated monomer (i.e., the “core monomers”) in the reaction mixture is from 1:100 to 20:100, such as from 5:100 to 15:100. In some examples, the weight ratio of the acrylic polymer stabilizer to the “core monomers” is from 10:100 to 100:10, such as from 20:100 to 100:20.

When an aliphatic polyester stabilized seed polymer is included in the reaction mixture, the non-aqueous dispersion (c) can be prepared, for example, as follows. A mixture of the seed stage stabilizer and seed monomer(s), such as an ethylenically unsaturated monomer, can be added to a hydrocarbon solvent such as ISOPAR E (isoparaffinic hydrocarbon solvent available from ExxonMobil Chemical) at an elevated temperature such as 90° C., over a period of time such as over 30 minutes. The ratio of seed stage stabilizer to seed monomer can be from 0.2:1.0 to 4.0:1.0 such as from 0.5:1.0 to 2.0:1.0. A radical initiator, such as azobis-2,2′-(2-methylbutyronitrile), can be added to the reaction mixture over approximately the same time period. The initiator is chosen so that it will induce radical polymerization of the seed monomer at the selected reaction temperature. The radical initiator may comprise 1% to 10%, such as 4% to 8%, of the composition of the reactants by weight. During the addition, the mixture can be agitated at a suitable speed, such as from 200 to 300 rpm. After the addition of the seed stage stabilizer, the seed monomer(s), and the radical initiator is complete, the resulting mixture can be from about 2% to 12%, such as from about 4% to 10%, weight solids. The mixture can be held at the same elevated temperature for an additional period of time, such as 30 minutes. The preceding process yields the aliphatic polyester stabilized seed polymer. At this point, the mixture can be isolated and stored for use at a later time. Alternatively, the mixture can be used immediately.

To the mixture of the aliphatic polyester stabilized seed polymer can be added a mixture of acrylic polymer stabilizer and an ethylenically unsaturated monomer at an elevated temperature, such as 90° C., over a period of time, such as over 180 minutes. In some embodiments, additional aliphatic polyester stabilized seed polymer, such as 0.5 to 5.0 percent by weight, or 1.0 to 2.0 percent by weight, based on total weight of the monomers used in preparing the non-aqueous dispersion may be added with the mixture of the acrylic polymer stabilizer and the ethylenically unsaturated monomer. A chain transfer agent, such as N-octylmercaptan, may be added with the acrylic polymer stabilizer, ethylenically unsaturated monomer, and/or seed stage stabilized seed polymer, at about 0.5 to 5.0 percent by weight, such as 1.0 to 2.0 percent by weight. The ethylenically unsaturated monomer(s) are described above. A radical initiator, such as azobis-2,2′-(2-methylbutyronitrile), can be added to the reaction mixture over approximately the same time period. The initiator is chosen so that it will induce radical polymerization of the core monomers at the selected reaction temperature. The radical initiator may comprise 0.2% to 5.0%, such as 0.5% to 2.0%, of the composition of the reactants by weight. After the addition of the acrylic stabilizer, the ethylenically unsaturated monomer(s), and the radical initiator is complete, the resulting mixture may be held at the reaction temperature for an extended period of time, such as 120 minutes, during which additional initiator may be added to ensure complete conversion of the monomers. Progress of the reaction may be monitored by solids measurement, or by gas chromatography. After the process is complete, the resulting non-aqueous dispersion of the present invention may be from about 15% to 70%, such as from 20% to 65%, 22% to 62%, or 32% to 52%, weight solids.

Any of the non-aqueous dispersions described herein further include a continuous phase, sometimes referred to as a dispersing medium or carrier. Any suitable carrier can be used including an ester, ketone, glycol ether, alcohol, hydrocarbon or mixtures thereof. Suitable ester solvents include alkyl acetates such as ethyl acetate, n-butyl acetate, n-hexyl acetate, and mixtures thereof. Examples of suitable ketone solvents include methyl ethyl ketone, methyl isobutyl ketone, and mixtures thereof. Examples of suitable hydrocarbon solvents include toluene, xylene, aromatic hydrocarbons such as those available from Exxon-Mobil Chemical Company under the SOLVESSO trade name, and aliphatic hydrocarbons such as hexane, heptanes, nonane, and those available from Exxon-Mobil Chemical Company under the ISOPAR and VARSOL trade names. In certain embodiments the carrier is volatile. In certain other embodiments the carrier is not an alkyd and/or any other fatty acid containing compound.

It will be appreciated by those skilled in the art that the non-aqueous dispersions used in the curable film-forming compositions of the present invention are distinct from latices, which are aqueous dispersions. The present non-aqueous dispersions are also distinct from a polymer solution, in that the non-aqueous dispersions have a distinct, dispersed phase that is different from the continuous phase, while a polymer solution has a single, homogeneous phase. A “non-aqueous dispersion” as used herein is one in which 75% or greater, such as 90% or greater, or 95% or greater of the dispersing media is a non-aqueous solvent, such as any of those listed above. Accordingly, a non-aqueous dispersion can still comprise some level of aqueous material, such as water.

The dispersion polymerization reaction product in the non-aqueous dispersion typically has an average particle size of 1 μm or less, such as 500 nm or less, such as 250 nm or less, often 200-250 nm. Particle size is measured by dynamic light scattering such as with a Malvern Zetasizer, which is a high performance two angle particle size analyzer for the enhanced detection of aggregates and measurement of small or dilute samples, and samples at very low or high concentration using dynamic light scattering. Typical applications of dynamic light scattering are the characterization of particles, emulsions or molecules, which have been dispersed or dissolved in a liquid. The Brownian motion of particles or molecules in suspension causes laser light to be scattered at different intensities. Analysis of these intensity fluctuations yields the velocity of the Brownian motion and hence the particle size using the Stokes-Einstein relationship. The reported particle sizes for all examples are the Z average mean value.

Usually the dispersion polymerization reaction product of the non-aqueous dispersion (c) is present in the curable film-forming composition in an amount of at least 0.5 percent by weight, or at least 1 percent by weight, based on the total weight of resin solids in the curable film-forming composition. Also, the dispersion polymerization reaction product of the non-aqueous dispersion (c) may be present in the curable film-forming composition in an amount of at most 10 percent by weight, or at most 8 percent by weight, based on the total weight of resin solids in the curable film-forming composition.

The curable film-forming compositions of the present invention further comprise (d) fumed silica, typically in the form of a dispersion. Fumed silica is made from flame pyrolysis of silicon tetrachloride or from quartz sand, vaporized in a 3000° C. electric arc. Any fumed silica known in the art as suitable rheology control agents may be used. Manufacturers include Evonik Resource Efficiency GmbH (who sells it under the name Aerosil), Cabot Corporation (Cab-O-Sil), Wacker Chemie (HDK), Dow Corning, Heraeus (Zandosil), Tokuyama Corporation (Reolosil), OCI (Konasil), Orisil (Orisil) and Xunyuchem (XYSIL). AEROSIL R812 fumed silica (available from Evonik Resource Efficiency GmbH) is particularly suitable. The fumed silica can be dispersed in the polymeric binder (a) and/or the curing agent (b) or another resin prior to addition to the curable film-forming composition. Additionally or alternatively, a fumed silica dispersion may be added to the curable film-forming composition with the non-aqueous dispersion (c) as a “rheology modifying” package.

Usually the fumed silica (d) is present in the curable film-forming composition in an amount of at least 0.5 percent by weight, based on the total weight of resin solids in the curable film-forming composition, such as at least 1 percent by weight. Also, the fumed silica (d) may be present in the curable film-forming composition in an amount of at most 5 percent by weight, or at most 4 percent by weight. The total combined amount of (c) and (d) in the curable film-forming composition is 1 to 15 percent by weight on resin solids, usually 2 to 12 percent by weight on resin solids, often 3 to 8 percent by weight on resin solids.

As used herein, the phrase “based on the total weight of resin solids” of the composition means that the amount of the component added during the formation of the composition is based upon the total weight of the resin solids (non-volatiles) of the film forming materials, including cross-linkers, reactive diluents, and polymers present during the formation of the composition, but not including any water, solvent, or any additive solids such as hindered amine stabilizers, photoinitiators, pigments including extender pigments and fillers, flow modifiers, catalysts, and UV light absorbers.

The use of the non-aqueous dispersion (c) of the dispersion polymerization reaction product often improves the “hold-out” between coating layers when the curable film-forming composition of the present invention is used in a multicomponent composite coating. As used herein, the term hold-out refers to preventing or minimizing significant mixing between a first applied uncured coating composition and the subsequently applied uncured coating composition(s), i.e., the layers remain largely separate and distinct. This mixing occurs when solvents from the subsequently applied coating composition migrate into the previously applied coating. Thus, the present invention allows for maintenance of separate and distinct layers in a wet-on-wet, or wet-on-wet-on-wet, application. A coating system that does not have good hold-out between the layers may have poor appearance, such as dullness or poor longwave and/or shortwave appearance as defined below.

In certain examples of the present invention, the curable film-forming composition further comprises colloidal silica different from the fumed silica described above. This is particularly desirable when the curable film-forming composition is used as an outermost topcoat, such as a transparent topcoat, in a multi-layer coating system. Any colloidal silica may be used; it is believed to provide scratch resistance to the composition after it is applied to a substrate as a coating and cured. A particular example is Colloidal Silica MT-ST available from Nissan Chemical Industries. As demonstrated in the Examples below, the colloidal silica may be dispersed in a separate resin prior to addition to the curable film-forming composition.

The curable film-forming compositions of the present invention may additionally include other optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used they are present in the composition in an amount of 0.1 to 2 percent by weight, based on the total weight of resin solids in the film-forming composition. Other optional additives may be included such as colorants, plasticizers, abrasion-resistant particles, film strengthening particles, fillers, catalysts such as dodecylbenzene sulfonic acid blocked with diisopropanolamine or N,N-Dimethyldodecylamine, antioxidants, biocides, defoamers, surfactants, wetting agents, dispersing aids, adhesion promoters, UV light absorbers and stabilizers, a stabilizing agent, organic cosolvents, reactive diluents, grind vehicles, and other customary auxiliaries, or combinations thereof.

Examples of suitable reactive diluents include epoxy functional materials, including monoepoxides and polyepoxides. A particular example of such a reactive diluent is 3,4-epoxycyclohexyl methyl 3,4-epoxycyclohexane carboxylate, available from Trico under the name ACHWL CER 4221. Reactive diluents contribute to the resin solids content of the composition as noted above.

As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discrete “composite microparticles” that comprise a nanoparticle and a resin coating on the nanoparticle. Example dispersions of resin-coated nanoparticles and methods for making them are identified in U.S. application Ser. No. 10/876,315 filed Jun. 24, 2004, and published on Dec. 29, 2005, as United States Patent Application Publication Number 2005/0287348, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. Special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

A photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one example, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

The photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component have minimal migration out of the coating. Example photosensitive compositions and/or photochromic compositions and methods for making them are identified in U.S. application Ser. No. 10/892,919 filed Jul. 16, 2004, now U.S. Pat. No. 8,153,344, and incorporated herein by reference.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

Substrates to which compositions of the present invention may be applied include rigid metal substrates such as ferrous metals, aluminum, aluminum alloys, copper, and other metal and alloy substrates. The ferrous metal substrates used in the practice of the present invention may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. The substrate may alternatively comprise a polymer or a composite material such as a fiberglass composite. Car parts typically formed from thermoplastic and thermoset materials include bumpers and trim.

Steel substrates (such as cold rolled steel or any of the steel substrates listed above) coated with a weldable, zinc-rich or iron phosphide-rich organic coating are also suitable for use in the present invention. Such weldable coating compositions are disclosed in U.S. Pat. Nos. 4,157,924 and 4,186,036. Cold rolled steel is also suitable when pretreated with an appropriate solution known in the art, such as a metal phosphate solution, an aqueous solution containing at least one Group IIIB or IVB metal, an organophosphate solution, an organophosphonate solution, and combinations thereof, as discussed below. Examples of aluminum alloys include those alloys used in the automotive or aerospace industry, such as 2000, 6000, or 7000 series aluminums; 2024, 7075, 6061 are particular examples. Alloys may be unclad or they may contain a clad layer on one or more surfaces, the clad layer consisting of a different aluminum alloy than the base/bulk alloy beneath the clad layer.

The substrate may alternatively comprise more than one metal or metal alloy in that the substrate may be a combination of two or more metal substrates assembled together such as hot-dipped galvanized steel assembled with aluminum substrates. The substrate may comprise part of a vehicle. “Vehicle” is used herein in its broadest sense and includes all types of vehicles, such as but not limited to airplanes, helicopters, cars, trucks, buses, vans, golf carts, motorcycles, bicycles, railroad cars, tanks and the like. It will be appreciated that the portion of the vehicle that is coated according to the present invention may vary depending on why the coating is being used.

The shape of the metal substrate can be in the form of a sheet, plate, bar, rod or any shape desired, but it is usually in the form of an automobile part, such as a body, door, fender, hood or bumper. The thickness of the substrate can vary as desired.

The curable film-forming composition may be applied directly to the metal substrate when there is no intermediate coating between the substrate and the curable film-forming composition. By this is meant that the substrate may be bare, as described below, or may be treated with one or more pretreatment compositions as described below, but the substrate is not coated with any coating compositions such as an electrodepositable composition or a primer composition prior to application of the curable film-forming composition of the present invention.

As noted above, the substrates to be used may be bare metal substrates. By “bare” is meant a virgin metal substrate that has not been treated with any pretreatment compositions such as conventional phosphating baths, heavy metal rinses, etc. Additionally, bare metal substrates being used in the present invention may be a cut edge of a substrate that is otherwise treated and/or coated over the rest of its surface. Alternatively, the substrates may undergo one or more treatment steps known in the art prior to the application of the curable film-forming composition.

The substrate may optionally be cleaned using conventional cleaning procedures and materials. These would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products. Such cleaners are generally followed and/or preceded by a water rinse. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes.

According to the present invention, at least a portion of a cleaned aluminum substrate surface may be deoxidized, mechanically or chemically. As used herein, the term “deoxidize” means removal of the oxide layer found on the surface of the substrate in order to promote uniform deposition of the pretreatment composition (described below), as well as to promote the adhesion of the pretreatment composition coating to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, Mich.), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating.

A metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. The pretreatment solutions may be essentially free of environmentally detrimental heavy metals such as chromium and nickel. Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of a yttrium compound is yttrium nitrate. An example of a cerium compound is cerous nitrate.

Typical compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL®.

In the aerospace industry, anodized surface treatments as well as chromium based conversion coatings/pretreatments are often used on aluminum alloy substrates. Examples of anodized surface treatments would be chromic acid anodizing, phosphoric acid anodizing, boric acid-sulfuric acid anodizing, tartaric acid anodizing, sulfuric acid anodizing. Chromium based conversion coatings would include hexavalent chromium types, such as Bonderite® M-CR1200 from Henkel, and trivalent chromium types, such as Bonderite® M-CR T5900 from Henkel.

The curable film-forming composition of the present invention may be applied to the substrate using conventional techniques including dipping or immersion, spraying, intermittent spraying, dipping followed by spraying, spraying followed by dipping, brushing, or roll-coating and non-atomizing techniques such as material jetting

The coating compositions of the present invention may be used alone as a protective layer or may serve as a unicoat, or monocoat, layer. Alternatively, the compositions of the present invention may be in combination as primers, basecoats, and/or topcoats. Thus the present invention provides a coated substrate comprising a substrate and a film-forming composition applied to a surface of the substrate, forming a coating; wherein the film-forming composition comprises any of the curable film-forming compositions described above. The present invention also provides a multi-layer coated article comprising a first film-forming composition applied to a substrate to form a colored base coat, and a second, transparent film-forming composition applied on top of the base coat to form a clear top coat, wherein the transparent film-forming composition comprises the curable film-forming composition of the present invention as described above. The term “transparent”, as used for example in connection with a substrate, film, material and/or coating, means that the indicated substrate, coating, film and/or material is optically clear and has the property of transmitting light without appreciable scattering so that objects lying beyond are entirely visible. As used herein, transparent clear coats demonstrate a visible light transmittance (% Transmission, as defined by the equation % Transmission=100×10^{IL/10} using visible light) of at least 70%. In an exemplary method of determining light transmittance, a substrate with an applied coating is mounted between an electromagnetic radiation transmitter and receiver antennas with the coated side of the substrate facing the transmitter. The insertion loss (IL) is measured and refers to the amount of transmitted signal that is not detected at the receiver. This method assumes a “lossless” condition in which the substrate either does not absorb or absorbs an insignificant amount of the incident frequency. The % Transmission is calculated according to the equation above.

Suitable base coats include any of those known in the art, and may be waterborne, solventborne or powdered. The base coat typically includes a film-forming resin, crosslinking material and pigment. Non-limiting examples of suitable base coat compositions include waterborne base coats such as are disclosed in U.S. Pat. Nos. 4,403,003; 4,147,679; and 5,071,904.

After application of each composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 70 to 250° F. (27 to 121° C.) will be sufficient. More than one coating layer of the present composition may be applied if desired. Usually between coats, the previously applied coat is flashed; that is, exposed to ambient conditions for the desired amount of time. Ambient temperature typically ranges from 60 to 90° F. (15.6 to 32.2° C.), such as a typical room temperature, 72° F. (22.2° C.).

The thickness of the coating is usually from 0.1 to 3 mils (2.5 to 75 microns), such as 0.2 to 2.0 mils (5.0 to 50 microns). The coating composition may then be heated. In the curing operation, solvents are driven off and crosslinkable components of the composition are crosslinked. The heating and curing operation is sometimes carried out at a temperature in the range of from 70 to 250° F. (27 to 121° C.) but, if needed, lower or higher temperatures may be used. As noted previously, the coatings of the present invention may also cure without the addition of heat or a drying step. Additionally, the first coating composition may be applied and then the second applied thereto “wet-on-wet”, or at least one base coat may be applied on top of a primer before the primer is cured, followed by application of a clear coat to the base coat(s) before the base coat(s) is cured; i. e., “wet-on-wet-on-wet” or “3-wet”, and the entire multi-layer coating stack cured simultaneously in a compact process (also known as 3C1B). Alternatively, each coating composition can be cured before application of the next coating composition.

In the preparation of the multi-layer coated article of the present invention, a liquid or powder primer may be applied to the substrate to form a primer coating upon the surface of the substrate prior to applying the first film-forming composition, and then the first film-forming composition may be applied directly onto the primer coating. Again, the primer coating may be cured prior to application of the first film-forming composition, or at least one base coat may be applied on top of a primer before the primer is cured, followed by application of a clear coat to the base coat(s) before the base coat(s) is cured in a “wet-on-wet-on-wet” process, and then the entire multi-layer coating stack may be cured simultaneously in a compact process. The coated substrate may be held at a temperature and for a time sufficient to substantially cure the composite coating after all coating compositions have been applied to the substrate. Application and curing methods and conditions may be as described above.

Surface waviness is an indication of the roughness of a surface, and may be measured using a wave scan instrument such as the BYK Wavescan Plus available from BYK Gardner USA, which measures surface topography via an optical profile. The wave scan instrument uses a point source (i.e. laser) to illuminate the surface over a predetermined distance, for example 10 centimeters, at an angle of incidence of 60°. The reflected light is measured at the same, but opposite angle. As the light beam hits a “peak” or “valley” of the surface, a maximum signal is detected; when the beam hits a “slope” of a peak/valley a minimum signal is registered. The measured signal frequency is equal to double spatial frequency of the coating surface topography. The surface “waviness” is differentiated into “long-wavelength/LW (1.2-12 mm)” and “short-wavelength/SW (0.3-1.2 mm)” to simulate visual evaluation by the human eye. Data are divided into longwave and shortwave signals using a mathematical filter function. Each range in value from 0 to 50. Long-wavelength waviness represents the variance of the longwave signal amplitude, while the short-wavelength waviness represents variance of the shortwave signal amplitude. The long- and short-wavelength waviness of a coating surface can give an indirect measure of topography-influencing factors such as substrate roughness, and flow and leveling properties of coatings. Longwave values may be determined using a BYK Wavescan Plus instrument in accordance with the manufacturer's suggested method of operation. Longwave values of lesser magnitude are indicative of coatings that are smoother in appearance.

After application of a curable film-forming composition of the present invention to a substrate and after curing to form a cured coating, the cured coating formed from the curable film-forming composition typically demonstrates a Longwave value at least 20 percent lower than a similar cured coating formed from a composition that does not contain the non-aqueous dispersion (c) and fumed silica (d) described above. This is evident when the compositions are applied to both horizontal and vertically oriented substrate surfaces.

Each of the characteristics and examples described above, and combinations thereof, may be said to be encompassed by the present invention. The present invention is thus drawn to the following nonlimiting aspects:

1. A curable film-forming composition comprising:
(a) a polymeric binder comprising epoxy functional groups;
(b) a curing agent comprising acid functional groups that are reactive with the epoxy functional groups of (a);
(c) a non-aqueous dispersion comprising a dispersion polymerization reaction product of a reaction mixture comprising an ethylenically unsaturated monomer (“core monomers”) and an ethylenically unsaturated nonlinear, random, acrylic polymer stabilizer, wherein the dispersion polymerization reaction product in the non-aqueous dispersion is present in the curable film-forming composition in an amount of 0.5 to 10 percent by weight such as 1 to 8 percent by weight, based on the total weight of resin solids in the curable film-forming composition, and wherein the dispersion polymerization reaction product is different from the polymeric binder (a); and
(d) fumed silica, present in the curable film-forming composition in an amount of 0.5 to 5 percent by weight such as 1 to 4 percent by weight, based on the total weight of resin solids in the curable film-forming composition.
2. The curable film-forming composition according to aspect 1, comprising 5 to 50 percent by weight of polymeric binder (a), such as 10 to 35 percent by weight or 25 to 30 percent by weight, each based on the total weight of resin solids in the curable film-forming composition.
3. The curable film-forming composition according to aspect 1 or 2, comprising 5 to 75 percent by weight of curing agent (b), such as 10 to 60 percent by weight or 15 to 55 percent by weight or 5 to 50 percent by weight or 5 to 60 percent by weight, 10 to 50 percent by weight, 10 to 75 percent by weight, 15 to 50 percent by weight, 15 to 60 percent by weight, and 15 to 75 percent by weight, each based on the total weight of resin solids in the curable film-forming composition.
4. The curable film-forming composition according to any of aspects 1 to 3, wherein the polymeric binder (a) is selected from one or more of acrylic polymers, polyesters, polyurethanes, polyamides, polyethers, polythioethers, polythioesters, polyenes, and epoxy resins.
5. The curable film-forming composition according to aspect 4, wherein the polymeric binder (a) comprises an acrylic and/or a polyester polymer.
6. The curable film-forming composition according to any of aspects 1 or 5, wherein the curing agent (b) comprises an acid functional polyester or acrylic polymer.
7. The curable film-forming composition according to any of aspects 1 to 5, wherein the curing agent (b) comprises a half-acid ester which is based on the condensation of aliphatic polyols with aliphatic and/or aromatic polycarboxylic acids or anhydrides.
8. The curable film-forming composition according to any of aspects 1 to 7, wherein the acrylic polymer stabilizer comprises 50 percent by weight or greater residues derived from (meth)acrylic monomers, based on the total weight of the polymer.
9. The curable film-forming composition according to any of aspects 1 to 8, wherein the acrylic polymer stabilizer is prepared from a reaction mixture comprising one or more polyfunctional ethylenically unsaturated monomers.
10. The curable film-forming composition according to aspect 9, wherein the polyfunctional ethylenically unsaturated monomer(s) are used in an amount of 0.1 to 10 percent by weight, such as 0.25 to 5 percent by weight or 0.5 to 2 percent by weight, each based on the total weight of monomers used to prepare the acrylic polymer stabilizer.
11. The curable film-forming composition according to aspect 9 or 10, wherein the polyfunctional ethylenically unsaturated monomer comprises allyl (meth)acrylate and/or alkane diol di(meth)acrylate such as 1,6-hexandiol diacrylate.
12. The curable film-forming composition according to any of aspects 1 to 11, wherein the acrylic polymer stabilizer is prepared from a reaction mixture comprising 90 percent by weight or greater (meth)acrylic monomers, based on the total weight of monomers used in the formation of the acrylic polymer stabilizer.
13. The curable film-forming composition according to any of aspect 12, wherein the acrylic polymer stabilizer is prepared from a reaction mixture comprising 95 percent by weight or greater (meth)acrylic monomers such as 100 percent by weight (meth)acrylic monomers, based on the total weight of monomers used in the formation of the acrylic polymer stabilizer.
14. The curable film-forming composition according to any of aspects 1 to 13, wherein the acrylic polymer stabilizer is prepared from a reaction mixture comprising 30 percent by weight or less of polar (meth)acrylic monomers, e.g. hydroxyl functional (meth)acrylic monomers, such as 20 percent by weight or less or 15 percent by weight or less or 10 percent by weight or less, each based on the total weight of monomers used in the formation of the acrylic polymer stabilizer.
15. The curable film-forming composition according to any of aspects 1 to 13, wherein the acrylic polymer stabilizer is prepared from a reaction mixture comprising 50 percent by weight or greater of nonpolar (meth)acrylic monomers, such as 60 percent by weight or greater or 70 percent by weight or greater or 80 percent by weight or greater, each based on the total weight of monomers used in the formation of the acrylic polymer stabilizer.
16. The curable film-forming composition according to any of aspects 1 to 15, wherein the acrylic polymer stabilizer is prepared from a reaction mixture comprising one or more polyfunctional ethylenically unsaturated monomers and one or more additional ethylenically unsaturated monomers selected from methyl (meth)acrylate, ethyl (meth)acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl (meth)acrylate, styrene, alpha-methylstyrene, lauryl (meth)acrylate, stearyl (meth)acrylate, itaconic acid, and mixtures thereof.
17. The curable film-forming composition according to any of aspects 1 to 16, wherein the reaction mixture comprising an ethylenically unsaturated monomer (“core monomers”) that is reacted with the acrylic polymer stabilizer comprises one or more polyfunctional ethylenically unsaturated monomers.
18. The curable film-forming composition according to aspect 17, wherein the polyfunctional monomer(s) are used in an amount of >0 to 20 percent by weight, such as 1 to 10 percent by weight, based on the total weight of monomers reacted with the acrylic polymer stabilizer.
19. The curable film-forming composition according to any of aspects 1 to 18, wherein the reaction mixture comprising an ethylenically unsaturated monomer (“core monomers”) that is reacted with the acrylic polymer stabilizer comprises one or more ethylenically unsaturated monomers selected from methyl (meth)acrylate, ethyl (meth)acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl (meth)acrylate, styrene, alpha-methylstyrene, lauryl (meth)acrylate, stearyl (meth)acrylate, itaconic acid, and mixtures thereof.
20. The curable film-forming composition according to any of aspects 1 to 19, wherein the reaction mixture comprising an ethylenically unsaturated monomer (“core monomers”) that is reacted with the acrylic polymer stabilizer comprises less than 90 percent by weight of polar and/or functional monomers.
21. The curable film-forming composition according to any of aspects 1 to 20, wherein the reaction mixture used to prepare the dispersion polymerization reaction product further comprises an aliphatic polyester stabilized seed polymer.
22. The curable film-forming composition according to aspect 21, wherein the aliphatic polyester stabilized seed polymer is prepared from a seed stage stabilizer and one or more seed monomers.
23. The curable film-forming composition according to aspect 22, wherein the seed monomers are one or more ethylenically unsaturated monomers such as a (meth)acrylate monomer, e.g. methyl methacrylate.
24. The curable film-forming composition according to any of aspects 21 to 23, wherein the seed stage stabilizer comprises two segments: an aliphatic polyester component and a stabilizer component having a different polarity from the polyester.
25. The curable film-forming composition according to aspect 24, wherein the carbon to oxygen ratio of the aliphatic polyester component is from 4:1 to 20:1, such as from 6:1 to 12:1.
26. The curable film-forming composition according to aspect 25, wherein the aliphatic polyester component is poly-12-hydroxy stearic acid.
27. The curable film-forming composition according to any of aspects 24 to 26, wherein the seed stage stabilizer comprises 20 percent by weight to 65 percent by weight aliphatic polyester component, such as from 25 percent by weight to 60 percent by weight or 30 percent by weight to 55 percent by weight, or 33 percent by weight to 53 percent by weight polyester, with percent by weight based on the total weight of the components of the seed stage stabilizer.
28. The curable film-forming composition according to aspect 26 or 27, wherein the seed stage stabilizer is prepared by reacting poly-12-hydroxy stearic acid with a compound that comprises (meth)acrylate functionality as well as a second type of functional group that can react with the hydroxyl or acid functionality of the poly-12-hydroxy stearic acid to form a polyester intermediate and then reacting the polyester intermediate with one or more ethylenically unsaturated seed monomers such as selected from (meth)acrylic acid, methyl(meth)acrylate, ethyl(meth)acrylate, n-butyl(meth)acrylate, isobutyl(meth)acrylate, 2-ethylhexyl(meth)acrylate, isobornyl(meth)acrylate, 2-hydroxyethyl(meth)acrylate, 2-hydroxypropyl(meth)acrylate, (meth)acrylic acid, glycidyl(meth)acrylate, styrene, alpha-methylstyrene, lauryl(meth)acrylate, stearyl(meth)acrylate, itaconic acid, and mixtures thereof.
29. The curable film-forming composition according to aspect 28, wherein the compound that comprises (meth)acrylate functionality as well as a second type of functional group that can react with the hydroxyl or acid functionality of the poly-12-hydroxy stearic acid to form a polyester intermediate is glycidyl(meth)acrylate.
30. The curable film-forming composition according to aspect 28 or 29, wherein the polyester intermediate is reacted with a mixture of methyl methacrylate, glycidyl methacrylate, and methacrylic acid.
31. The curable film-forming composition according to any of aspects 21 to 30, wherein the weight ratio of the aliphatic polyester stabilized seed polymer to the ethylenically unsaturated monomer(s) (“core monomers”) in the reaction mixture to form the dispersion polymerization reaction product is from 1:100 to 20:100, such as from 5:100 to 15:100.
32. The curable film-forming composition according to any of aspects 1 to 31, wherein the weight ratio of the acrylic polymer stabilizer to the ethylenically unsaturated monomer(s) (“core monomers”) in the reaction mixture to form the dispersion polymerization reaction product is from 10:100 to 100:10, such as from 20:100 to 100:20.
33. The curable film-forming composition according to any of aspects 1 to 32, wherein the dispersion polymerization reaction product in the non-aqueous dispersion has an Z average mean particle size of one micron or less such as 500 nm or less or 250 nm or less or 200 to 250 nm as measured by dynamic light scattering.
34. The curable film-forming composition according to any of aspects 1 to 33, wherein the dispersion polymerization reaction product in the non-aqueous dispersion (c) and the fumed silica (d) are present in the curable film-forming composition in a total amount of 1 to 15 percent by weight, such as 2 to 12 percent by weight, based on the total weight of resin solids in the curable film-forming composition.
35. The curable film-forming composition according to any of aspects 1 to 34, wherein the solids content of the non-aqueous dispersion (c) is 15 to 70 percent by weight, such as from 20 to 65 percent by weight or 22 to 62 percent by weight, or 32 to 52 percent by weight.
36. A multi-layer coated article comprising a first film-forming composition applied to a substrate to form a colored base coat, and a second, transparent film-forming composition applied on top of the base coat to form a clear top coat, wherein the transparent film-forming composition comprises the curable film-forming composition of any of aspects 1 to 35.
37. The multi-layer coated article according to aspect 36 wherein the transparent film-forming composition further comprises colloidal silica.

Illustrating the invention are the following examples that are not to be considered as limiting the invention to their details. All parts and percentages in the examples, as well as throughout the specification, are by weight unless otherwise indicated.

A non-aqueous dispersion (NAD) was prepared as follows (Examples 1 to 4):

### Example 1

A polyester intermediate 1 for a seed stage stabilizer was prepared in accordance with Example 1 in United States Patent Application Publication Number 2014/0128508 A1.

### Example 2

An aliphatic Seed Stage Stabilizer 2 was prepared in accordance with Example 2 in United States Patent Application Publication Number 2014/0128508 A1.

### Example 3

A hyperbranched Acrylic Stabilizer 3 was prepared as follows:

| Ingredient | Parts by Weight |
|---|---|
| Charge 1 | |
| Butyl Acetate | 148.1 |
| AROMATIC 100¹ | 296.1 |
| Charge 2 | |
| LUPEROX 270² | 44.9 |
| AROMATIC 100 | 61.6 |
| Charge 3 | |
| Methyl Methacrylate | 114.1 |
| 2-Ethylhexyl Acrylate | 114.1 |
| Glycidyl Methacrylate | 34.2 |
| Butyl Acrylate | 228.1 |
| Hydroxyethyl Methacrylate | 114.1 |
| 1,6-Hexanediol Diacrylate | 17.0 |
| Isobornyl Acrylate | 536.0 |
| Charge 4 | |
| LUPEROX 270 | 4.49 |
| AROMATIC 100 | 6.16 |
| Charge 5 | |
| 4-Methoxyphenol | 1.34 |
| Armeen DMCD³ | 2.8 |
| AROMATIC 100 | 6.2 |
| Charge 6 | |
| Methacrylic acid | 3.96 |

¹AROMATIC 100 is a solvent produced from petroleum-based raw materials, having an aromatic content of at least 99%, composed primarily of C9-10 dialkyl and trialkyl benzenes, available from ExxonMobil Chemical.
²LUPEROX 270 is t-butyl-per-3,5,5-trimethylhexanoate, available from Arkema, Inc.
³ARMEEN DMCD is a dimethyl cocoamine surfactant, available from Akzo Nobel Chemicals B. V..

The Acrylic Stabilizer 3 was prepared from the ingredients above in accordance with Example 3 in United States Patent Application Publication Number 2014/0128508 A1, with the following exceptions: the reaction mixture was not cooled to 110° C., but was kept at 125° C. At 125° C., Charge #4 was added over 10 min, and then the reaction mixture was held at 125° C. for 1 hour. After the 1-hour hold, the nitrogen inlet was switched to a sparge of a mixture of N₂/O₂ at a 95/5% mol ratio. After sparging for 30 min, Charge #5 was added to the reaction flask (over 10 min) followed by Charge #6 (over 10 min). The reaction mixture was held at 110° C. for 2 hours.

### Example 4

The non-aqueous dispersion was prepared as follows:

| | |
|---|---|
| Ingredients | Parts by Weight |

Charge #1

| | |
|---|---|
| Heptane | 271.6 |
| ISOPAR E¹ | 551.6 |

Charge #2

| | |
|---|---|
| Methyl Methacrylate | 70.0 |
| Stabilizer (Example 2) | 137.1 |
| ISOPAR E | 159.0 |

Charge #3

| | |
|---|---|
| VAZO 67² | 30.9 |
| AROMATIC 100 | 114.2 |

Charge #4

| | |
|---|---|
| 4-Hydroxybutyl acrylate | 338.3 |
| Styrene | 457.6 |
| Methyl Methacrylate | 318.4 |
| Glycidyl Methacrylate | 42.4 |
| Methacrylic acid | 15.9 |
| Stabilizer (Example 2) | 79.5 |
| Stabilizer (Example 3) | 515.1 |
| ARMEEN DMCD | 6.29 |
| n-Octylmercaptan | 20.6 |
| ISOPAR E | 689.4 |

Charge #5

| | |
|---|---|
| VAZO 67 | 30.9 |
| AROMATIC 100 | 477.4 |

¹ISOPAR E is a solvent produced from C8 and C9 isoparaffins, available from ExxonMobil Chemical.
²VAZO 67 is 2,2′-azobis(2-nethylbutyronitrile), available from The Chemours Company.

The NAD was prepared from the ingredients above in accordance with Example 5 in United States Patent Application Publication Number 2014/0128508 A1, with the following exceptions: Charge #1 was added into a 5-liter, 4-necked flask equipped with a motor-driven steel stir blade, a thermocouple, a nitrogen inlet, and a water-cooled condenser. The reaction mixture was heated to 100° C. by a mantle controlled by the thermocouple via a temperature feedback control device. Charges #2 and #3 were added dropwise via addition funnel over 30 min, and then the reaction mixture was held at 100° C. for 30 min. After the hold, Charge #4 and #5 were added over 4 hours and then the reaction mixture was held at 100° C. for 2 hours.

Six clearcoat compositions were prepared from the following mixture of ingredients. Example A demonstrates the preparation of a curable film-forming composition according to the present invention; Examples B to F are comparative; Examples B and C are comparative because they do not contain an NAD; Examples D to F are comparative because they do not contain fumed silica.

TABLE 1

| | Example | | | | | |
|---|---|---|---|---|---|---|
| Components | A | B | C | D | E | F |
| Ethyl 3- | 80.86 | 80.86 | 80.86 | 80.86 | 80.86 | 80.86 |
| ethoxypropanoate | | | | | | |
| FlexiSolv | 27.54 | 27.54 | 27.54 | 27.54 | 27.54 | 27.54 |
| Dimethyl esters¹ | | | | | | |
| EVERSORB 93² | 1.74 | 1.74 | 1.74 | 1.74 | 1.74 | 1.74 |
| GMA Acrylic³ | 246.29 | 246.29 | 246.29 | 246.29 | 246.29 | 246.29 |
| ACHWL CER | 39.15 | 39.15 | 39.15 | 39.15 | 39.15 | 39.15 |
| 4221⁴ | | | | | | |
| RESIMENE | 82.37 | 82.37 | 82.37 | 82.37 | 82.37 | 82.37 |
| HM-2608⁵ | | | | | | |
| DYNOADD F-1 | 1.55 | 1.55 | 1.55 | 1.55 | 1.55 | 1.55 |
| solution⁶ | | | | | | |
| BYK-331⁷ | 0.15 | 0.15 | 0.15 | 0.15 | 0.15 | 0.15 |
| DISPARLON | 0.44 | 0.44 | 0.44 | 0.44 | 0.44 | 0.44 |
| OX-60⁸ | | | | | | |
| N-pentyl | 60.58 | 60.58 | 60.58 | 60.58 | 60.58 | 60.58 |
| propionate | | | | | | |
| CHIGUARD 328⁹ | 13.30 | 13.30 | 13.30 | 13.30 | 13.30 | 13.30 |
| Acid crosslinker | 203.97 | 203.97 | 203.97 | 203.97 | 203.97 | 203.97 |
| A¹⁰ | | | | | | |
| Acid crosslinker | 13.66 | 13.66 | 13.66 | 13.66 | 13.66 | 13.66 |
| B¹¹ | | | | | | |
| Acid crosslinker | 55.50 | 55.50 | 55.50 | 55.50 | 55.50 | 55.50 |
| C¹² | | | | | | |
| N,N-dimethyl | 10.40 | 10.40 | 10.40 | 10.40 | 10.40 | 10.40 |
| dodecyl amine | | | | | | |
| Isostearic acid | 18.45 | 18.45 | 18.45 | 18.45 | 18.45 | 18.45 |
| Silica grind | 35.24 | 35.24 | 70.48 | — | — | — |
| R-812¹³ | | | | | | |
| Colloidal Silica | 13.80 | 13.80 | 13.80 | 13.80 | 13.80 | 27.60 |
| dispersion A¹⁴ | | | | | | |
| Non-aqueous | 26.00 | — | — | 26.00 | 52.00 | 26.00 |
| dispersion of | | | | | | |
| Example 4 | | | | | | |

¹Mixture of dicarboxylic dimethylesters (dimethyl succinate, dimethyl glutarate, and dimethyl adipate) available from Invista Corporation
²Hindered amine light stabilizer available from Everlight Chemical Taiwan
³Epoxy functional acrylic polymer prepared as described in the U.S. Pat. No. 5,196,485, Example A
⁴3,4-epoxycyclohexyl methyl 3,4-epoxycyclohexane carboxylate reactive diluent available from Trico chemical company, China
⁵methylated melamine-formaldehyde curing agents commercially available from INEOS Melamines.
⁶Polymeric, non-silicone general-purpose additive available from Dynea
⁷Polyether modified polydimethylsiloxane additive available from BYK (Altana Group)
⁸Additive based on an acrylic polymer, available from Kusumoto Chemicals, Ltd.
⁹UV absorbers commercially available from Chitec Technology Co., Ltd.
¹⁰Prepared according to U.S. Pat. No. 5,196,485, Example G (70% solid in a solvent mixture of 5% propanol and 95% N-butyl acetate)
¹¹Prepared according to U.S. Pat. No. 5,196,485, Example J (73% solids in a solvent mixture of 26% mineral spirit and 74% N-butyl acetate)
¹²Prepared according to U.S. Pat. No. 5,196,485, Example H (80% solid in a solvent mixture of 17% ethanol and 83% methyl isobutyl ketone)
¹³A dispersion of 8% AEROSIL R812 silica (available from Evonik Resource Efficiency GmbH) mixed with 42% Amyl Alcohol and 50% of a half-ester resin as disclosed in the U.S. Pat. No. 5,196,485 Example G.
¹⁴Colloidal Silica Dispersion A is Colloidal Silica MT-ST available from Nissan Chemical Industries dispersed in a modified siloxane polyol resin. The dispersion is made in a stepwise process:
1) Synthesis of the siloxane polyol resin using SILRES SY 816VP (Methyl hydrogen polysiloxane resin fromWacIcer Chemie AG) and Trimethylolpropanemonoallyl ether using a hydrosilation reaction to form a Siloxane Polyol resin at 100% solids with a GPC weight average molecular weight of 6,500.
2) Adding MethylAmyl Ketone solventto the Siloxane Polyol resin to obtain a weight solids of 72%.
3) Adding the NISSAN CHEMICAL Colloidal Silica MT-ST (supplied at 30 wt % solids in Methanol) to the reduced siloxane polyol resin of step 2.
4) Removal ofthe Methanol solvent using distillation.
5) Chemical modification ofthe Siloxane Polyol resin with Methyl HHPA and Cardura E-10 in the presence of additional Methyl Amyl Ketone to form a final product made of 31.4 wt % SILRES SY816VP, 12.4 wt % NISSAN CHEMICAL MT-ST Colloidal Silica, 18.5 wt % Methyl HHPA and 37.7 wt % CARDURA E-10 made using 0.0015 wt % N,N-Dimethyl Benzyl Amine catalyst.
6) The final product is a colloidal dispersion of silica particles with about 12 nm average particle size in Siloxane Polyol resin supplied in Methyl Amyl Ketone at 74% weight solids.

A black pigmented waterborne basecoat commercially available from PPG as HWB9517 was spray applied in an environment controlled to 70-75° F. (21-24° C.) and 60-70% relative humidity onto 4 inch by 12 inch (10 cm by 30 cm) steel panels that were coated with PPG powder primer (PCV70500) and PPG electrocoat (ED6100C), both commercially available from PPG. The substrate panels were obtained from ACT Test Panels, LLC of Hillsdale, Mich. The basecoat was applied in two coats with a 1 minute flash between coats, and then flashed at ambient temperature for 2 minutes. The film thicknesses were approximately 0.6-0.8 mils (15-20 microns). The clearcoat examples were reduced to 90-95 cP, as measured by a Brookfield CAP-2000 viscometer at 100 RPM using a #10 spindle. Each clearcoat was spray applied over basecoated panels in an environment controlled to 70-75° F. (21-24° C.) and 60-70% relative humidity to simulate OEM conditions. A portion of the panels were oriented horizontally immediately after application (H) while others were kept in a vertical orientation (V). The clearcoats were applied in two coats with a 1 minute flash between coats. The clearcoated panels were allowed to flash for 10 minutes at ambient conditions and then baked for 30 minutes at 260° F. (127° C.). The film thickness was approximately 2.0 mils (50 microns).

The appearance results of coated horizontal (H) and vertical (V) panels were measured by a BYK Wavescan Plus instrument in accordance with the manufacturer's suggested method of operation. The “Rating” is a number provided by the instrument based on combined longwave (LW) and shortwave (SW) measurements. Higher BYK Rating values, lower long wave, lower short wave, lower dullness values and lower sag are more desirable for appearance.

TABLE 2

| | Appearance result | | | | | |
|---|---|---|---|---|---|---|
| Examples | H/V | Rating | LW | SW | Dullness | Sag (mm) |
| A | H | 10.3 | 2 | 8.6 | 1 | — |
| | V | 8.4 | 4.8 | 9.2 | 1.3 | 3 |
| B | H | 10.3 | 2 | 9.2 | 1 | — |
| | V | 8.7 | 4.2 | 9.6 | 8.8 | 8.6 |
| C | H | 8.7 | 4.3 | 7.2 | 1 | — |
| | V | 7.3 | 8.5 | 11 | 1.1 | 2.4 |
| D | H | 10.5 | 1.1 | 7.6 | 1 | — |
| | V | 7.7 | 7 | 9.6 | 1.9 | 15.3 |
| E | H | 10.5 | 1.4 | 8.1 | 1 | — |
| | V | 7.9 | 6.4 | 9.5 | 1 | 9.8 |
| F | H | 10.5 | 1.6 | 10.2 | 1 | |
| | V | 7.7 | 6.9 | 8.8 | 1.2 | 18 |

Comparative Example B, which did not contain a non-aqueous dispersion, demonstrated vertical dullness and significant vertical sag compared to the composition of the present invention (Example A). Comparative Example C, which did not contain a non-aqueous dispersion, and Comparative Examples D to F, which did not contain fumed silica, demonstrated poor vertical ratings compared to the composition of the present invention (Example A).

Whereas particular examples of this invention have been described above for purposes of illustration, it will be evident to those skilled in the art that numerous variations of the details of the present invention may be made without departing from the scope of the invention as defined in the appended claims.

What is claimed is:

1. A curable film-forming composition comprising:
(a) a polymeric binder comprising epoxy functional groups;
(b) a curing agent comprising acid functional groups that are reactive with the epoxy functional groups of (a);
(c) a non-aqueous dispersion comprising a dispersion polymerization reaction product of a reaction mixture comprising an ethylenically unsaturated monomer and an ethylenically unsaturated nonlinear, random, acrylic polymer stabilizer, wherein the dispersion polymerization reaction product in the non-aqueous dispersion is present in the curable film-forming composition in an amount of 0.5 to 10 percent by weight, based on the total weight of resin solids in the curable film-forming composition, and wherein the dispersion polymerization reaction product is different from the polymeric binder (a); and
(d) fumed silica, present in the curable film-forming composition in an amount of 0.5 to 5 percent by weight, based on the total weight of resin solids in the curable film-forming composition.

2. The curable film-forming composition according to claim 1, wherein the polymeric binder (a) comprises an acrylic and/or a polyester polymer.

3. The curable film-forming composition according to claim 1, wherein the curing agent (b) comprises an acid functional polyester or acrylic polymer.

4. The curable film-forming composition according to claim 1 wherein the acrylic polymer stabilizer is prepared from a polyfunctional ethylenically unsaturated monomer.

5. The curable film-forming composition according to claim 4, wherein the polyfunctional ethylenically unsaturated monomer comprises allyl (meth)acrylate and/or alkane diol di(meth)acrylate.

6. The curable film-forming composition according to claim 1, wherein the acrylic polymer stabilizer is prepared from a reaction mixture comprising 90 percent by weight or greater (meth)acrylic monomers.

7. The curable film-forming composition according to claim 1, wherein the acrylic polymer stabilizer is prepared from a reaction mixture comprising 95 percent by weight or greater (meth)acrylic monomers.

8. The curable film-forming composition according to claim 1, wherein the reaction mixture used to prepare the dispersion polymerization reaction product further comprises an aliphatic polyester stabilized seed polymer.

9. The curable film-forming composition according to claim 1, wherein the dispersion polymerization reaction product in the non-aqueous dispersion has an average particle size of 500 nm or less.

10. The curable film-forming composition according to claim 1, wherein the dispersion polymerization reaction product in the non-aqueous dispersion (c) and the fumed silica (d) are present in the curable film-forming composition in a total amount of 1 to 15 percent by weight, based on the total weight of resin solids in the curable film-forming composition.

11. A multi-layer coated article comprising a first film-forming composition applied to a substrate to form a colored base coat, and a second, transparent film-forming composition applied on top of the base coat to form a clear top coat, wherein the transparent film-forming composition comprises the curable film-forming composition of claim 1.

12. The multi-layer coated article according to claim 11, wherein the polymeric binder (a) comprises an acrylic and/or a polyester polymer.

13. The multi-layer coated article according to claim 11, wherein the curing agent (b) comprises an acid functional polyester or acrylic polymer.

14. The multi-layer coated article according to claim 11 wherein the stabilizer is prepared from a polyfunctional ethylenically unsaturated monomer.

15. The multi-layer coated article according to claim 11 wherein the transparent film-forming composition further comprises colloidal silica that is different from the fumed silica.

16. The multi-layer coated article according to claim 11, wherein the dispersion polymerization reaction product in the non-aqueous dispersion (c) and the fumed silica (d) are present in the transparent film-forming composition in a total amount of 1 to 15 percent by weight, based on the total weight of resin solids in the transparent film-forming composition.
